(19) United States
(12) Patent Application Publication
(10) Pub. No.: US 2007/0072688 A1
(43) Pub. Date: Mar. 29, 2007

(54) Driveshaft system

(76) Inventors: John Anthony Dickson, Newtown Square, PA (US); Duane Edward Bendzinski, Howell, MI (US); Douglas C. Larsen, Highland, MI (US)

Correspondence Address: INTELLECTUAL PROPERTY, ALCOA TECHNICAL CENTER, BUILDING C, 100 TECHNICAL DRIVE, ALCOA CENTER, PA, 15069-0001, US

(21) Appl. No.: 11/485,173

(22) Filed: Jul. 12, 2006

Related U.S. Application Data
(60) Provisional application No. 60/698,747, filed on Jul. 13, 2005.
(60) Provisional application No. 60/698,740, filed on Jul. 13, 2005.

(51) Int. Cl. F16C 3/00

(52) U.S. Cl. 464/180

(57) ABSTRACT

The present invention provides a dampening system including a driveline including a tubular driveshaft; and at least one attenuator positioned at frequency nodes within the tubular driveshaft, the attenuator including a dampening material disposed about a perimeter of a rigid carrier corresponding to an interior surface of the tubular driveshaft, the rigid carrier uniformly distributing the high frequency dampening material about the interior surface of the tubular driveshaft. The present invention also provides a method for uniformly distributing an expandable material about the interior surface of a tubular driveshaft.

### CROSS REFERENCE TO RELATED APPLICATIONS

The present invention claims the benefit of U.S. provisional patent application 60/698,747, filed Jul. 13, 2005, and U.S. provisional patent application 60/698,740, filed Jul. 13, 2005, the whole contents and disclosure of which are incorporated by reference as is fully set forth herein.

### FIELD OF THE INVENTION

The present invention relates to a sound and vibration dampening system for use in transportation vehicles.

### BACKGROUND OF THE INVENTION

Torque transmitting shafts are widely used for transferring rotational power between a source of rotational power and a rotatably driven mechanism. An example of a torque transmitting shaft is a driveshaft tube used in a vehicle driveshaft assembly. The driveshaft assembly transmits rotational power from a source, such as an engine, to a driven component, such as a pair of wheels.

A typical vehicle driveline assembly includes a hollow cylindrical driveshaft tube having an end fitting secured to each end thereof. Usually, the end fittings are embodied as end yokes which are adapted to cooperate with respective universal joints. For example, a driveshaft assembly of this general type is often used to provide a rotatable driving connection between the output shaft of a vehicle transmission and an input shaft of an axle assembly for rotatably driving the vehicle wheels. Traditionally, driveshaft tubes were made from steel. More recently, aluminum driveshafts have been developed because of their lighter weight, reduced system cost, and ability to be more readily balanced when used in larger diameters for the purpose of increasing the resident frequency or critical rotational speed of the respective driveshaft assembly.

One problem encountered by all types of driveline assemblies is their tendency to produce and transmit sound while transferring the power of the engine to the axle assembly. It is known that any mechanical body has a natural resonant frequency. This natural resonant frequency is an inherent characteristic of the mechanical body and is based upon many factors, including its composition, size and shape. The natural resonant frequency is made up of many sub-frequencies, often referred to as harmonics. As the vehicle is operated through its normal speed range (i.e. from 0 mph to about 80 mph), the rotational velocity of the driveshaft assembly changes (i.e. from 0 rpm to about 5000 rpm). As the rotational velocity of the driveshaft changes, it passes through the harmonic frequencies of the body's resonant frequency. When the rotational velocity of the driveshaft passes through these harmonic frequencies, vibration and noise may be amplified since the two frequencies are synchronized and the rotational energy of the driveshaft is converted into vibration and noise. This noise can be undesirable to passengers riding in the vehicle. Thus, it would be advantageous to deaden or reduce the sound produced by a vehicle driveshaft assembly in order to provide the passengers with a more quiet and comfortable ride.

Various attempts have been made to deaden the sound produced by vehicle driveshaft tubes. One general direction that many of these attempts have followed is to place a vibration/noise absorbing/deadening structure within the driveshaft. For example, one attempt involves disposing a hollow cylindrical cardboard insert inside an aluminum or steel driveshaft tube to deaden the sound. Another cardboard insert required external rubber ribs to prevent it from sliding inside the aluminum driveshaft tube and dissipate vibration within the molecular structure of the rubber. As a result, the cardboard insert is relatively complicated and expensive to employ. Other attempts at deadening the sound and attenuating frequencies involve completely or partially filling the driveshaft tube with relatively non-resonant material such as steel wool, cotton, elastic foams, and even plaster. The use of external and internal dampening devices of steel and rubber construction so known as ITD's and, plugs of compressible and slightly resilient material such as cork or rubber.

As exemplified by the number of proposed solutions to the sound problem in driveshafts, the particular solution for a specific type of driveshaft is not always straightforward. For instance, there are questions concerning what types of materials are most effective and suitable for the type of driveshaft employed. In addition, there are questions concerning the added weight, cost and performance of the material chosen for the noise reduction structure.

Therefore, a need exists for a noise reduction structure to be utilized in an aluminum-based driveshaft tube which is lightweight, inexpensive, and long-lasting. In addition, it would particularly be desirable to provide this lighter, less expensive, noise reduction structure for an aluminum-based driveshaft tube which is as or more effective in reducing the sound levels of such a driveshaft tube than the known noise reduction structures and mechanisms.

### SUMMARY OF THE INVENTION

The above needs and more are provided by the present driveshaft including one or more attenuators strategically positioned at the harmonic frequency nodes of the driveshaft, in which the attenuator includes a dampening material about the perimeter of a rigid. carrier, wherein the rigid carrier (also referred to as a rigid carrier) uniformly distributes the dampening material about the interior of the driveshaft to provide a balanced distribution of dampening material. Each attenuator is slideably inserted into the driveshaft and then bonded to strategic locations of the interior surface of the driveshaft. In one embodiment, the dampening material is expanded during an actuation step and engaged to the driveshafts interior. Broadly, the inventive driveshaft assembly includes:
a driveline of a motor vehicle including a tubular driveshaft; and
at least one attenuator positioned within the tubular driveshaft, the attenuator comprising dampening material disposed about a perimeter of a rigid carrier corresponding to an interior surface of the tubular driveshaft, wherein the rigid carrier provides a balanced distribution of the dampening material about the interior surface of the tubular driveshaft.

The attenuator includes a dampening material that may be expandable upon activation and provides engagement to the interior surface of the tubular driveshaft. In some embodiments, the dampening material is selected to dampen sound frequencies or vibrations that are typically produced by mechanical movement and interaction of the driveline components, such as differentials, transmissions, transaxles, half-shafts, universal joints, and velocity joints. The rigid carrier provides a means for uniformly distributing the dampening material about the interior surface of the tubular driveshaft, to ensure that the driveshaft may be balanced. The rigid carrier also provides structural rigidity to the tubular driveshaft. Specifically, the rigid carrier substantially reduces dimensional changes in the diameter of tubular driveshaft during operation.

In one embodiment of the present invention, in addition to dampening the frequencies or vibrations produced by the mechanical movement and interaction of the driveline components, the rigid carrier dampens a second range of sound frequencies or vibrations that are produced by dimensional changes in the driveshaft's diameter by increasing the structural rigidity of the driveshaft.

Another aspect of the present invention is a method of forming a dampening driveshaft. Broadly, the inventive method includes:
providing a tubular driveshaft having an interior surface;
inserting at least one attenuator within the tubular driveshaft at frequency nodes, wherein the attenuator includes a dampening material disposed around a perimeter of a rigid carrier; and
activating the dampening material into engagement with the interior surface of the tubular driveshaft, wherein the rigid carrier confines the dampening material in a balanced distribution about the interior surface of the tubular driveshaft and substantially reduces dimensional changes in a diameter of the tubular driveshaft.

Another aspect of the present invention is a method of distributing an expandable material in balanced distribution about the interior of a driveshaft. Broadly, the inventive method includes:
providing a tubular driveshaft having an interior surface;
providing a rigid carrier housing an expandable material, the rigid carrier having an exterior geometry corresponding to the interior surface of the tubular driveshaft, wherein the expandable material is disposed upon the exterior geometry of the rigid carrier;
   inserting the rigid carrier within the tubular driveshaft; and
   activating the expandable material into engagement with the interior surface of the tubular driveshaft, wherein the rigid carrier contains the expandable material upon activation in a balanced distribution about the interior surface of the tubular driveshaft.

### BRIEF DESCRIPTION OF THE DRAWINGS

A full understanding of the invention can be gained from the following description of the preferred embodiments when read in conjunction with the accompanying drawings in which:

FIG. 1 (side cross-sectional view) depicts one embodiment of the inventive driveline system including a tubular driveshaft having a single attenuator disposed therein.

FIG. 2 (side cross-sectional view) depicts one embodiment of the inventive tubular driveshaft having a centrally positioned attenuator.

FIG. 3 (side cross-sectional view) depicts another embodiment of the inventive tubular driveshaft having a first attenuator positioned at ⅓ the length of the driveshaft and a second attenuator positioned at ⅔ the length of the driveshaft.

FIG. 4a (side cross-sectional view) depicts another embodiment of the tubular driveshaft having a swaged cross-section.

FIG. 4b (side sectional view) depicts one embodiment of the swaged portions of the tubular driveshaft having a swaged cross section.

FIG. 5 (prospective view) depicts one embodiment of the attenuator having a rigid carrier and a dampening material disposed about the perimeter of the rigid carrier.

FIG. 6 (side cross-sectional view) depicts an attenuator installed within a tubular driveshaft, as depicted in FIG. 1, wherein a retaining lip provides a containment means for the expanding dampening material.

### DETAILED DESCRIPTION OF PREFERRED EMBODIMENTS

The present invention is now discussed in more detail referring to the drawings that accompany the present application. In the accompanying drawings, like and/or corresponding elements are referred to by like reference numbers.

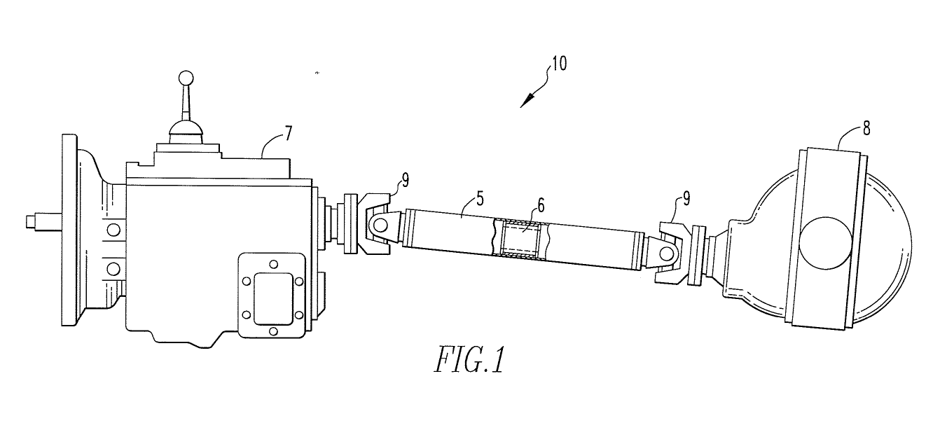

Referring to FIG. 1, a driveline assembly 10 is depicted in accordance with the present invention. Generally, the driveline assembly 10 comprises a driveshaft 5, motor (not shown), transmission 7 and differential 8. The tubular driveshaft 5 in accordance with this invention has improved sound deadening properties to reduce noise and vibration from driveline components including, but not limited to: differentials 8, transmissions 7, transaxles (not shown), half-shafts (not shown), and universal joints/constant velocity joints 9. The present invention achieves this benefit by disposing a noise reduction structure 6 (hereafter referred to as an attenuator) within the tubular driveshaft 5.

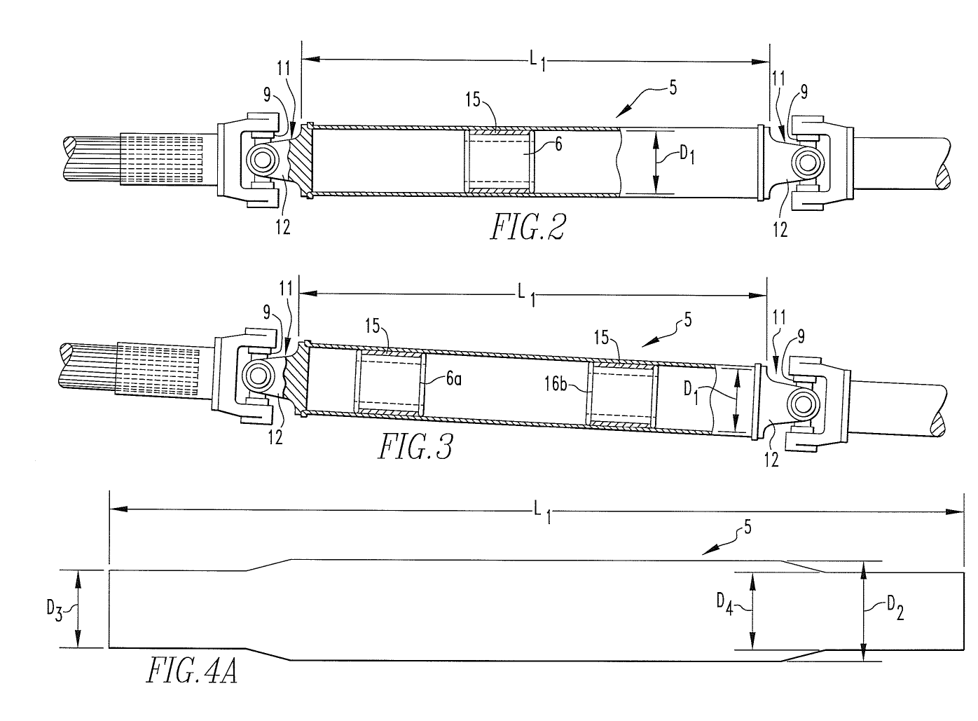

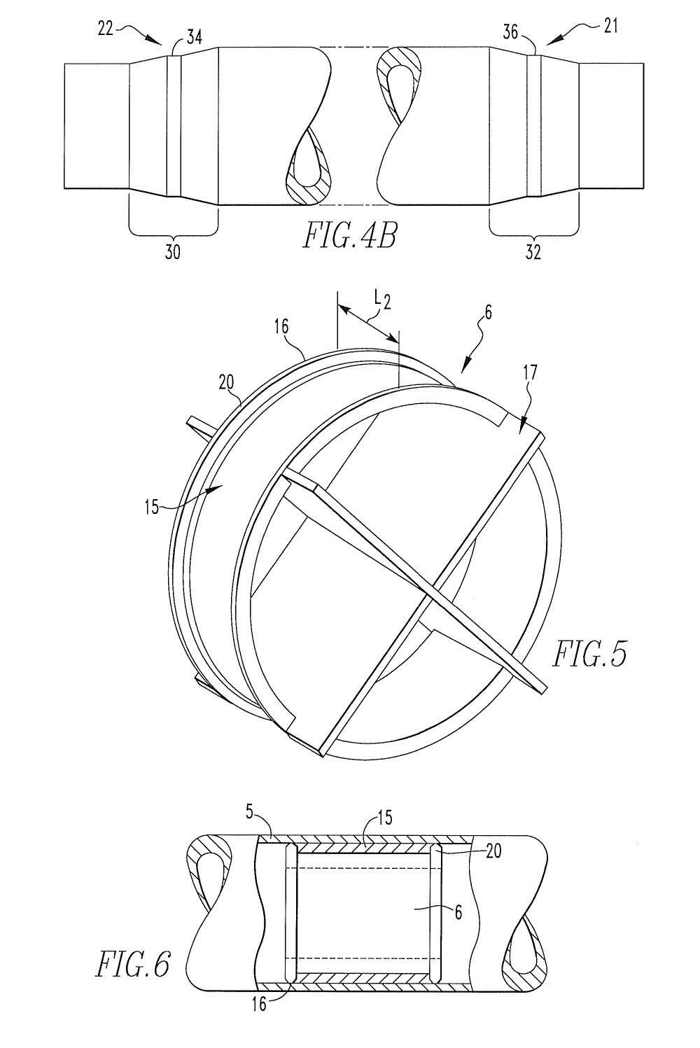

The tubular driveshaft 5 of the present invention may have a constant diameter D₁, as depicted in FIGS. 2 and 3, or may have a swaged configuration, as depicted in FIG. 4. Specifically, a swaged driveshaft can be formed having a larger diameter center portion D₂, an end portion having a reduced diameter D₃, and a diameter reducing portion D₄ positioned between the center and end portions.

Preferably, the tubular driveshaft 5 is formed from a single piece of metal, but multiple piece driveshaft tubes can alternatively be used. The tubular driveshaft 5 can be formed from any suitable material. Typically, the tubular driveshaft 5 is formed from steel or an aluminum alloy. Preferably, the tubular driveshaft 5 is formed from an aluminum alloy. Suitable methods for forming the tubular driveshaft 5 are well known to persons skilled in the art and may include, but are not limited to: hot extrusion via seamless or bridge die processes, cold drawing, or continuous seam welding of a tube made from roll formed flat sheet.

In one embodiment, a method for forming a tubular driveshaft having a swaged configuration includes at least the steps of providing an 6000 series type alloy hollow elongate tube; and reducing the diameter of at least one portion of the hollow elongate tube to form a reduced diameter section and transition section between the reduced diameter section and the tube; the transition section having at least three subsections: i. a first subsection having a first slope; ii. a second subsection having a second slope; and iii. a third subsection located between the first and second subsections having a third slope which is less than the first and second slopes, the third section forming a circumferential step to stiffen the transition section.

Referring to FIG. 4b , in one embodiment, the transition sections 30 and 32 of the swaged portions 21, 22 of the driveshaft may have a generally conical shape. The taper on transition sections 30 and 32 is about 80° to 16° and preferably about 10° to 14°. The taper of transition sections 30 and 32 is preferably non-linear. Near the center of each of transition section 30 and 32 is a circumferential “step” 34 and 36 which stiffens transition section 30 and 32, respectively. Step 34 has a taper of about 0° to 5° relative to the long axis of the driveshaft.

The swaged portions 2l, 22 of the driveshaft 5 having a smaller diameter tube portion than the central portion of the driveshaft may be swaged using rotary swaging or push pointing. Rotary swaging is a technique wherein opposing dies are rapidly hammered against the outside diameter of the tube to swage down the diameter to a smaller diameter. Push pointing is a technique wherein a tube or pipe of given diameter is pushed through a tapered reducing die to neck down or reduce the initial tube diameter.

In one preferred embodiment, the aluminum alloy for the tubular driveshaft contains about 0.5 to 1.3% Mg, about 0.4 to 1.2% Si, about 0.6 to 1.2% Cu, about 0.1 to 1% Mn, the balance substantially aluminum and incidental elements and impurities. In another preferred embodiment, the invention drive shafts includes AA alloy 6013, in which Aluminum Association composition limits for alloy 6013 are 0.6 to 1% Si, 0.8 to 1.2% Mg, 0.6 to 1.1% Cu, 0.2 to 0.8% Mn, 0.5% max. Fe, 0.1% max. Cr, 0.25% max. Zn, 0.1% max. Ti, other elements 0.05% each, 0.15% total, the balance substantially aluminum.

In one embodiment, providing the 6000 series type alloy hollow elongate tube may include the process steps of extrusion, cold drawing, solution heat, quench, and artificial aging. In one embodiment, extrusion of the hollow elongate tube may be conducted at temperatures at or above 400° F., typically from about 500° F. to about 700° F., to provide a more uniform or relatively fine recrystallization grain size.

A more detailed description of a method for forming a swaged driveshaft is disclosed in U.S. Pat. No. 6,247,346, to Dickson, titled “Method of Forming a Drive Shaft”, filed Jun. 19, 2001, and incorporated herein by reference for all purposes.

Referring to FIGS. 2 and 3, the ends of the tubular driveshaft 5 are open and are adapted for receiving an end fitting 11 following the insertion of at least one attenuator 6. In one embodiment, the end fitting 11 may be a tube yoke disposed within each end of the tubular driveshaft 5. In general, each tube yoke 11 typically includes a tube seat at one end and a lug structure 12 at the other end. The tube seat is a generally cylindrical-shaped member which is adapted to be inserted into an open end of the tubular driveshaft 5. Accordingly, the tube seat enables torque to be transmitted between the tubular driveshaft 5 and the tube yoke 11. Typically, the tube yoke 11 is secured to the driveshaft tube by a weld 12. Each tube yoke 11 provides for engagement to a universal joint 9, or equivalent, which in turn provides mechanical communication to transmissions and/or differentials.

The dimensions of the driveshaft are typically dependent on application. As an example, a tubular driveshaft 5 may have an inner diameter of about 54 millimeters to about 146 millimeters and an outer diameter of about 60 millimeters to about 150 millimeters. The length L₁ of the tubular driveshaft 5 may range from about 375 millimeters to about 2100 millimeters. The wall thickness of the tubular driveshaft 5 may range from about 2 millimeters to about 4 millimeters. Typically, when aluminum is employed as the tubular driveshaft 5 material, the ratio of diameter to wall thickness is on the order of 18 (60 OD×3 mm wall) to 70 (150 OD×2.3 mm wall).

Referring now to FIG. 5, the attenuator 6 positioned within the tubular driveshaft 5 comprises a dampening material 15 disposed around the perimeter of a rigid carrier 20. The dampening material 15 provides for sound and vibration dampening and provides for secure engagement of the attenuator 6 within the tubular driveshaft 5. More specifically, in some embodiments, the dampening material 15 provides secure engagement by expanding and bonding to the interior surface of the tubular driveshaft 5 upon activation of the dampening material 15. As used in the present invention, the terms “activated” and “activation” denote that the expandable material can be activated to cure (e.g. thermoset), expand (e.g. foam), soften, flow or a combination thereof.

In one embodiment of the present invention, the dampening material 15 expands upon activation and exerts pressure between the rigid carrier 20 and the interior surface of the tubular driveshaft 5, wherein the compressive force exerted on the rigid carrier 20 secures the attenuator 6 within the tubular driveshaft 5. In one embodiment of the present invention, the dampening material 15 expands upon activation in adhesive engagement with the interior surface of the tubular driveshaft 5.

Preferably, the dampening material 15 is an expandable material that may be heat activated at a temperature consistent with existing automotive and transportation manufacturing processes, even more preferably activating in a temperature range consistent with aluminum driveshaft tube manufacturing processes (i.e., artificial aging or precipitation hardening). The heat activated material may flow, cure (e.g. thermosettable), foam, expand (e.g. foam) or a combination thereof upon exposure to heat. One example of a temperature range consistent with driveshaft manufacturing processes ranges from 300° F. to 400° F. If needed, blowing agent activators can be incorporated into the composition to cause expansion at different temperatures outside the above ranges. Generally, suitable expandable foams have volumetric range of expansion ranging from approximately 100% to 400%. Although heat activated materials are preferred, the dampening material 15 may be activated into expansion and engagement with the interior surface of the tubular driveshaft 5 by alternative means.

In a preferred embodiment, the dampening material 15 displays a high degree of crosslinking upon curing to achieve its final shape. The higher the degree of crosslinking the greater the resistance to shape change or flow once the dampening material 15 has cured. Any material that is heat-activated and expands and cures in a predictable and reliable manner under conditions consistent with driveshaft manufacturing, while meeting structural and acoustical requirements for the selected application, can be used.

The vibration attenuation requirements of the dampening material 15 may be selected to meet the requirement of each application. In one embodiment of the present invention, it is preferred that the dampening material 15 be selected to attenuate sound waves and vibrations in a range of frequencies produced by driveline components, including, but not limited to: differentials, transmissions, transaxles, half-shafts, universal joints, and velocity joints. Typically, this frequency range includes higher frequencies ranging from about 300 Htz to about 700 Htz. It is noted that the dampening material is not limited to materials that dampen the above frequency range since the dampening material may be selected for any frequency range required for different applications.

In some embodiments of the present invention, the dampening material 15 is a foamable or adhesive material, which includes or is based upon an epoxy resin, polyethylene, polyester, ethylene vinyl acetate, ethylene propylene diene rubber (EPDM), styrene-butadiene-styrene block copolymers, polyamide, or mixtures and combinations thereof. For example, without limitation the foam may be an epoxy-based material, including an ethylene copolymer or terpolymer that may posses an alpha-olefin. As a copolymer or terpolymer, the polymer is composed of two or three different monomers, i.e., small molecules with high chemical reactivity that are capable of linking up with similar molecules.

A number of epoxy-based or otherwise based sealing, baffling or acoustic foams are known in the art and may be employed in the present invention. A typical foam includes a polymeric based material, such as an epoxy resin, an EVA or ethylene-based polymer which, when compounded with appropriate ingredients, (blowing and curing agent), expands and cures in a reliable and predicable manner upon the application of heat or the occurrence of a particular ambient condition. Examples of blowing agents include azodicarbonamide and P, P′-oxybis (benzene sulfonyl hydrazide). Examples of curing agents include dicyandiamide and cyanoguanidine. Id. From a chemical standpoint, for a thermally-activated material, the foam is usually initially processed as a flowable thermoplastic and/or thermosettable material before curing. In a preferred embodiment, the dampening material 15 will cross-link (e.g. thermoset) upon curing, resulting in a cured material incapable of further flow.

Some other possible materials include, but are not limited to, polyolefin materials, copolymers and terpolymers with at least one monomer type of alpha-olefin, phenol/formaldehyde materials, phenoxy materials, and polyurethane materials with high glass transition temperatures. In other embodiments of the present invention, the dampening material 15 may include polyamide or include thermosets such as vinyl ester resins, thermoset polyester resins and urethane resins. In general, the desired material will have good adhesion durability properties.

Other exemplary expandable materials can include combinations of two or more of the following: polystyrenes, styrene-butadiene rubber, nitrile-butadiene rubber (NBR), butadiene acrylo-nitrile rubber, styrene butyl styrene (SBS) block co-polymers, epoxy resin, azodicarbonamides, urea-based catalysts such as N,N dimethylphenyl urea, sulfur, dicyandiamide, amorphous silica, and glass microspheres. Other examples of expandable materials are sold under the tradename SIKAELASTOMER®, SIKADAMP®, SIKAREINFORCER®, SIKAFOAM®, SIKASEAL®, and SIKABAFFLE® and are commercially available from the Sika Corporation, Madison Heights, Mich.

In some embodiments of the present invention, the dampening material 15 may be at least partially coated with an active polymer having damping characteristics or an other heat activated polymer, (e.g., a formable hot melt adhesive based polymer or an expandable structural foam, examples of which include olefinic polymers, vinyl polymers, thermoplastic rubber-containing polymers, epoxies, urethanes or the like).

In a preferred embodiment, the dampening material 15 can be processed by injection molding, extrusion, compression molding or with a mini-applicator.

Still referring to FIG. 5, the rigid carrier 20 employed in the attenuator 6 has a substantially hollow cylindrical shape having dimensions which allow for low resistance slideable insertion of the attenuator 6 within the tubular driveshaft 5. For example, the outside diameter of the rigid carrier 20 may range from about 54 mm to about 146 mm, the inside diameter of the rigid carrier 20 may range from about 52 mm to about 144 mm, and the length of the rigid carrier 20 may range from about 35 mm to about 75 mm. Generally, the length L₂ of each attenuator 6 is approximately 2% the length L₁ of the tubular driveshaft 5.

Referring to FIG. 6, the rigid carrier 20 provides a means for uniformly distributing the dampening material 15 about the interior surface of the tubular driveshaft 5 in a manner that allows for the tubular driveshaft 5 to be balanced. In one embodiment, an equal amount of dampening material 15 is disposed about the perimeter of the rigid carrier 20 to ensure that a balanced proportion of dampening material 15 is distributed along the inside surface of the tubular driveshaft 5. In one embodiment, the rigid carrier comprises a solid rim about a substantially hollow center portion, in which the dampening (expandable) martial is disposed around the exterior portion of the solid rim. The rigid carrier 20 ensures a balanced distribution of dampening material along the inside surface of the tubular driveshaft 5 by containing the activated dampening material 15 within a space defined between the interior surface of the tubular driveshaft 5 and the exterior surface of the rigid carrier 20. By providing a balanced distribution of dampening material the driveshaft may be balanced consistent with typical driveshaft processing.

Referring to FIGS. 5 and 6, the rigid carrier 20 preferably includes a retaining lip 16 at each end of the rigid carrier 20. The retaining lip 16 facilitates the containment of the dampening material 15 upon activation and expansion. More specifically, in one embodiment, the height of the upper surfaces of the retaining lip 16 are selected to be in slideable contact with the tubular driveshaft's interior surfaces to ensure that the expanding dampening material is contained in balanced distribution between the retaining lip 16, the exterior surface of the rigid carrier 20 and the interior surface of the tubular driveshaft 5. Alternatively, the space separating the upper surfaces of the retaining lip 16 from the tubular driveshaft's 5 interior surfaces is minimized to provide a containment means for the expanding dampening material 15.

The rigid carrier 20 may also include cross bracing 17 extending to opposing portions of the rigid carrier's perimeter through a central portion of the attenuator 6. The cross bracing 17 can provide both structural stiffness to the rigid carrier 20, and an insertion contact to facilitate insertion of the attenuator 6 within the tubular driveshaft 5 prior to activation of the dampening material 15. As an added advantage, the cross bracing 17 divides the air-space across the diameter of the tubular driveshaft 5 into smaller constituents. By dividing the air space across the diameter into smaller constituents, the cross bracing 17 may increase the frequencies of noise and/or vibrations produced, conducted, or transmitted by the tubular driveshaft 5. By increasing the frequencies of the noise and/or vibrations, the likelihood that such frequencies will travel through solid structures of the driveline is substantially reduced.

In some embodiments of the present invention, the rigid carrier 20 dampens a range of frequencies for noise and/or vibration that is outside of the range of frequencies that may be dampened by the dampening material 15. The frequency range dampened by the rigid carrier 20 may overlap with the frequency range dampened by the dampening material 15 or the frequency ranges may be distinct. In one embodiment, the rigid carrier 20 substantially reduces dimensional changes in the diameter of the tubular driveshaft 5 and therefore reduces noise and vibration frequencies resulting from those dimensional changes in the driveshaft diameter. These dimensional changes can be so described as changes in the tube's circularity, particularly for the case of such tubes with diameter to wall ratios greater than 65, caused by torque pulses created by driveline architecture. Without wishing to be bound, it is believed that changes in the tubular driveshaft's diameter (tube periphery elastically moving from round to oval) compress and decompress adjacent air in much the same manner as an audio speaker, thus creating low frequency sound in the range of 50 Htz to 100 Htz. Typically, noise and vibration frequencies resulting from dimensional changes in the driveshaft diameter are low frequencies ranging from about 50 Htz to 100 Htz. In a preferred embodiment, in which the dampening material 15 dampens frequencies ranging from 100 Htz to 700 Htz, the rigid carrier 20 is effective in dampening frequencies to a frequency of about 100 Htz or less.

The rigid carrier 20 may be produced from any high temperature resistant performance plastic which can withstand process environment conditions and automotive assembly plant oven temperatures without showing significant degradation in performance. That is, the rigid carrier 20 will retain its' size and shape at such temperatures experienced in the automotive assembly process without any detrimental deformation. Typical plastic materials include, but are not limited to, semi-crystalline or amorphous materials including, polyamides such as nylon 6, nylon 6/6, nylon 6/6/6, polyolefins such as polyethylene or polypropylene, syndiotactic vinyl aromatic polymers such as syndiotactic polystyrene (SPS) and any blends thereof. Other potential polymers include polyesters, polyesteramides, polyarylates, polyurethanes, polyureas, polyphenylene sulfides, and polyetherimides. It is noted that additional materials may be utilized for the rigid carrier 20, and are within the scope of the present disclosure, so long as the materials maintain structural and/or chemical stability through a temperature range suitable for manufacturing of components for using in transportation vehicles.

The rigid carrier 20 can be produced by any molding technique which will produce a cylinder having a set shape and size. Typical molding techniques include, but are not limited to, well known processes such as blow molding, injection molding, rotational molding, pressure forming, linear coextrusion of the rigid carrier's ring and subsequent rolling and bonding with the web material, and the like.

As discussed above, the tubular driveshaft 5 contains one or more attenuators 6 for dampening sound waves and vibrations that may be generated or amplified by the driveline. The location of each attenuator within the tubular driveshaft may be dependent on application and the location of each attenuator 6 may be selected to dampen specific frequency ranges. Preferably, the attenuators 6 may be positioned within the driveshaft 5 on harmonic frequency nodes. Referring to FIG. 2, in one example of the tubular driveshaft 5 of the present invention, a single attenuator 6 may be positioned centrally within the tubular driveshaft 5 with respect to the driveshaft's length L₁. Referring to FIG. 3, in another embodiment of the present invention, a first attenuator 6a is positioned at ⅓ the length of the tubular driveshaft 5 and a second attenuator 6b positioned at ⅔the length of the driveshaft 5. It is noted that any number of attenuators 6 and any number of locations for positioning the attenuators within the tubular driveshaft 5 have been contemplated and are within the scope of the present invention, so long as the attenuators 6 contribute to sound and vibration reduction through the driveline.

While the present invention has been particularly shown and described with respect to the preferred embodiments thereof, it will be understood by those skilled in the art that the foregoing and other changes in forms of details may be made without departing form the spirit and scope of the present invention. It is therefore intended that the present invention not be limited to the exact forms and details described and illustrated, but fall within the scope of the appended claims.

Having described the presently preferred embodiments, it is to be understood that the invention may be otherwise embodied within the scope of the appended claims.

What is claimed is:

1. A driveshaft system comprising:
a driveline of a motor vehicle comprising a tubular driveshaft; and
at least one attenuator positioned within the tubular driveshaft, the attenuator comprising a dampening material disposed about a perimeter of a rigid carrier corresponding to an interior surface of the tubular driveshaft, wherein the rigid carrier provides a balanced distribution of the dampening material about the interior surface of the tubular driveshaft.

2. The driveshaft system of claim 1 wherein the at least one attenuator is positioned at least one frequency node within the tubular driveshaft.

3. The driveshaft system of claim 1 wherein the attenuator substantially reduces acoustical wave propagation in the driveline of the motor vehicle.

4. The driveshaft system of claim 1 wherein the rigid carrier comprises a cylindrical configuration.

5. The driveshaft system of claim 4 wherein the cylindrical configuration comprises a solid rim about a substantially hollow center portion, wherein an outer surface of the solid rim is the perimeter on which the dampening material is disposed.

6. The driveshaft system of claim 5 wherein the rigid carrier comprises cross bracing across the hollow central portion of the rigid carrier.

7. The driveshaft system of claim 1 wherein the tubular driveshaft comprises aluminum.

8. The driveshaft system of claim 8 wherein the tubular driveshaft comprises a driveshaft diameter to driveshaft wall thickness ratio on the order of 18 or greater.

9. The driveshaft system of claim 1 wherein the at least one attenuator is positioned at a center of a length of the tubular driveshaft.

10. The driveshaft system of claim 1 wherein the at least one attenuator comprises a first attenuator positioned at ⅓ a length of said tubular driveshaft and a second attenuator positioned at ⅔ said length of the tubular driveshaft.

11. The driveshaft system of claim 1 wherein the at least one attenuator is positioned at frequency nodes within the tubular driveshaft and comprises a dampening material for dampening a first frequency range of sound waves or vibrations and the rigid carrier substantially reduces a second frequency range of sound waves or vibrations.

12. The system of claim 11 wherein said first frequency range of sound waves or vibrations is greater than the second frequency of sound waves or vibrations.

13. The system of claim 11 wherein a portion of said first frequency range overlaps with the second frequency range.

14. The system of claim 11 wherein the first frequency range comprises sound waves or vibrations is generated by differentials, transmissions, transaxles, half-shafts, universal joints, and velocity joints in the driveline.

15. The system of claim 11 wherein the second frequency range comprises sound waves or vibrations generated by dimensional changes in the tubular driveshaft.

16. The system of claim 11 wherein the rigid carrier further comprises retaining lips at opposing ends of the perimeter of the rigid carrier, wherein the retaining lips contain the dampening material in balanced engagement with the interior surface of the tubular driveshaft.

17. The system of claim 6 wherein the cross bracing segments the air space along a diameter of the tubular driveshaft, wherein the segmented air space within the tubular driveshaft increases noise and vibration frequencies produced by the tubular driveshaft.

18. A driveshaft comprising:
a tube having an interior surface; and
at least one least attenuator positioned at frequency nodes within the tube, wherein each of the at least one attenuator comprises a rigid carrier engaged to the interior surface of the tube by a dampening material, the rigid carrier having a geometry that contains the dampening material in a balanced engagement to the interior surface of the tube and substantially increases dimensional rigidity in a diameter of the tube.

19. The driveshaft of claim 18 further comprising end caps on opposing ends of said tube, wherein each of the end caps provide a connection to driveline components.

20. A method of manufacturing a driveshaft comprising:
providing a tubular driveshaft having an interior surface;
providing a rigid carrier housing an expandable material, the rigid carrier having an exterior geometry corresponding to the interior surface of the tubular driveshaft, wherein the expandable material is disposed upon the exterior geometry of the rigid carrier;
inserting the rigid carrier within the tubular driveshaft; and
activating the expandable material into engagement with the interior surface of the tubular driveshaft, wherein the rigid carrier confines the expandable material upon activation in a balanced distribution about the interior surface of the tubular driveshaft.

21. The method of claim 20 wherein the rigid carrier and the expandable material substantially reduces acoustical wave propagation.

22. The method of claim 21 wherein the geometry of the rigid carrier comprises a hollow cylindrical configuration.

23. The method of claim 20 wherein the rigid carrier comprises cross bracing along a central portion of the rigid carrier.

24. The method of claim 20 wherein the expandable material bonds to the interior surface of the tubular driveshaft.

25. The method of claim 20 wherein the rigid carrier further comprises retaining lips at opposing ends of the rigid carrier, wherein the retaining lips contain the expandable material in balanced engagement with the interior surface of the tubular driveshaft.

26. A method of manufacturing a driveshaft:
providing a tubular driveshaft having an interior surface;
inserting at least one attenuator within said tubular driveshaft at least one frequency node, wherein the attenuator comprises a dampening material disposed around a perimeter of a rigid carrier; and
activating the dampening material into engagement with said interior surface of the tubular driveshaft, wherein the rigid carrier contains the dampening material in a balanced distribution about the interior surface of the tubular driveshaft and substantially reduces dimensional changes in a diameter of the tubular driveshaft.

27. The method of claim 26 wherein the at least one attenuator comprises a dampening material for dampening a first frequency range of sound waves or vibrations and the rigid carrier substantially reduces a second frequency range of sound waves or vibrations.

28. The system of claim 27 wherein the first frequency range comprises sound waves or vibrations is generated by differentials, transmissions, transaxles, half-shafts, universal joints, and velocity.joints in the driveline.

29. The system of claim 27 wherein the second frequency range comprises sound waves or vibrations generated by dimensional changes in the tubular driveshaft.

30. The system of claim 6 wherein the rigid carrier further comprises cross bracing that segments the air space along a diameter of the tubular driveshaft, wherein the segmented air space within the tubular driveshaft increases noise and vibration frequencies produced by the tubular driveshaft.
